(19) United States
(12) Patent Application Publication
(10) Pub. No.: US 2013/0060874 A1
(43) Pub. Date: Mar. 7, 2013

(54) Method of Recording and Delivering Messages through an Online Platform

(71) Applicant: Robert STEPHENS, Glen Allen, VA (US)

(72) Inventor: Robert STEPHENS, Glen Allen, VA (US)

(21) Appl. No.: 13/601,684

(22) Filed: Aug. 31, 2012

Related U.S. Application Data
(60) Provisional application No. 61/530,258, filed on Sep. 1, 2011.

(51) Int. Cl. G06F 15/16

(52) U.S. Cl. 709/206

(57) ABSTRACT

A method of recording and delivering messages through an online platform includes a user account where the user account uploads the messages to the online platform. The user account includes a user profile and also creates a plurality of guest profiles where the plurality of guest profiles is assigned to view the uploaded messages. All of the uploaded messages are saved into a database through the online platform and secured until the user's death. The application software continuously searches through a vitality database for information which can be matched with the user profile. When a match is found for the user profile from the vitality database, the application software notifies a plurality of guests with a deceased notification link and a time sensitive password. The deceased notification link and the time sensitive password allow the plurality of guest to selectively view the uploaded messages.

The current application claims a priority to the U.S. Provisional Patent application Ser. No. 61/530,258 filed on Sep. 01, 2011.

### FIELD OF THE INVENTION

The present invention relates generally to a system and method for recording and delivering a message. More specifically, the method provides for a user to record a message and the system delivers the message at the time of the user's death only to selected individuals.

### BACKGROUND OF THE INVENTION

The death of a loved one is always a difficult time for friends and family. Friends and family often desire a final message from the deceased. It is now possible for people to record video, audio, and text messages and request that these messages not be opened until after death. It is therefore an object of the present invention to provide a means for an individual to control who can view personal messages, and to allow those messages to be accessed only after the individual has died. The present invention uses the internet to access data on the death of an individual and alerts a pre-determined list of loved ones. It is a further object of the present invention to provide an online site where the individual can choose from among multiple services for recording a message and may select for how long and how many times others may view the message after the user's death. The present invention creates a secured database in an online setting, but guarantees that the stored information in the database can only be opened after a pre-specified event has taken place.

### BRIEF DESCRIPTION OF THE DRAWINGS

FIG. 1 is a simplified flow chart illustrating the overall process of the present invention.

FIG. 2 is a simplified flow chart illustrating the process of creating a user account of the present invention.

FIG. 3 is a simplified flow chart illustrating the process of creating a plurality of guest profiles of the present invention.

FIG. 4 is a simplified flow chart illustrating the process of searching a vital statistic database of the present invention.

FIG. 5 is a simplified flow chart illustrating the process of sending a deceased notification link of the present invention.

### DETAIL DESCRIPTIONS OF THE INVENTION

All illustrations of the drawings are for the purpose of describing selected versions of the present invention and are not intended to limit the scope of the present invention.

The present invention is a web-based method of recording and delivering commemorative messages, where the commemorative messages are delivered to a selected group of individuals at a time of user's death. The present invention utilizes any appropriate technology, including existing and future technologies, to record and deliver the commemorative messages. It is an object of the present invention to utilize the internet to build a social platform that communicates between a deceased individual and the select group of individuals.

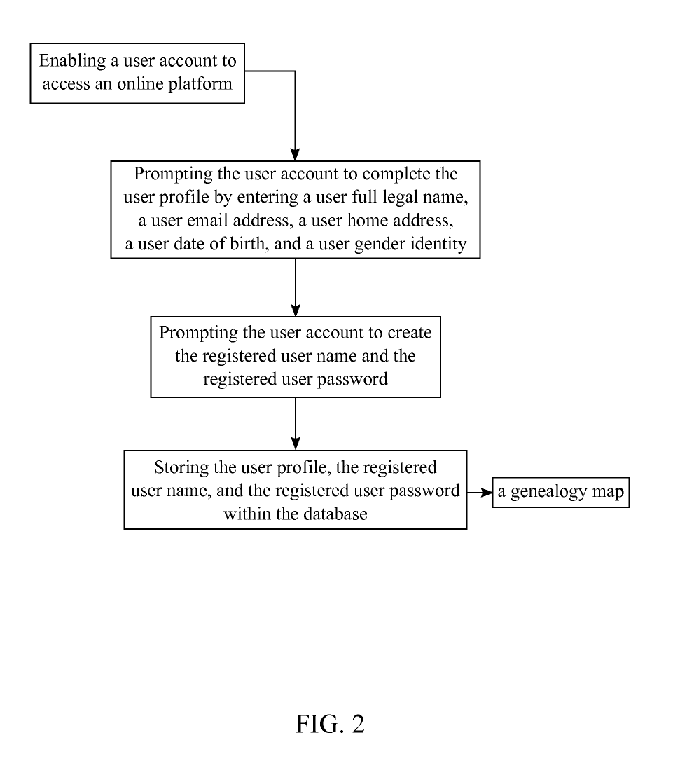

The present invention executes its function with an online platform such as a website. The user of the present invention needs to create a user account in order to access the online platform. The application software of the present invention displays a registration page through the online platform where the user is able to create the user account. In reference to FIG. 2, the user account includes a registered user name, a registered user password, and a user profile. The user needs to completely fill out the user profile and creates the registered user name and the registered user password. The registered user name and the registered user password requires at least four characters including letters, punctuation, symbols, and numbers so that the complexity can be attained for the online security of the user account while increasing the protection for the user account. The user profile includes a plurality of personal identifying information including but not limited to a user full legal name, a user email, a user address, a user date of birth, and a user gender identity. In order to gain access to the online platform, the user is required to pay a service fee during the registration process through an online transaction. The registered user name, the registered user password, and the user profile are saved into a database upon the completion of registration process. The database is interconnected with the online platform, thus allowing the database and the online platform to continuously function through the application software.

The user profile may also comprise a genealogy map. The application software in the present invention imports the user profile and assigns the user profile to the genealogy map. The genealogy map creates a family tree for the user profile with other related user profiles as the present invention increases the number of user accounts. All of the information regarding the genealogy map is saved within the database. The present invention may also exchange information between third party genealogy sites such as ancestry.com. The information collected from the user account is shared amongst genealogy sites so that the information can be utilized with third party genealogy site's databases.

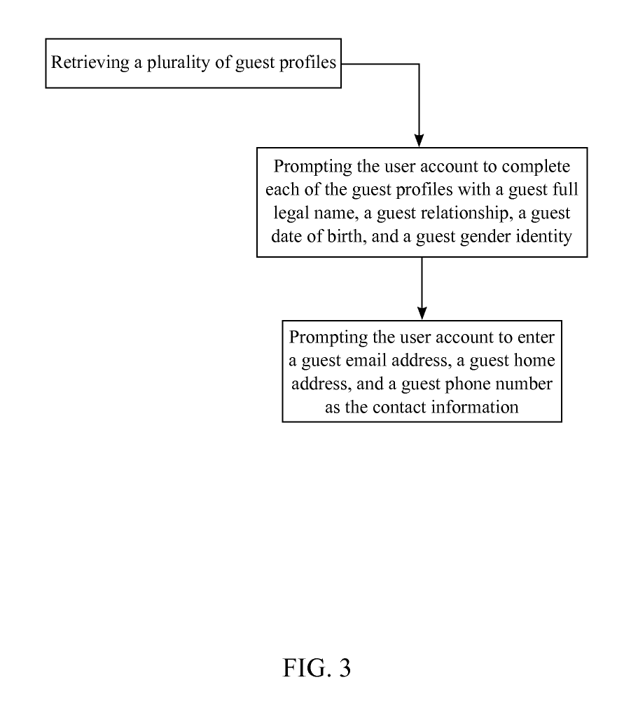

Once the user is able to access the present invention with the registered user name and the registered user password, the user can create a plurality of guest profiles. In reference to FIG. 3, each of the plurality of guest profiles is created by the user where the plurality of guest profiles ideally represents family members, friends, and any other individuals that need to be contact after the user's death. Each of the plurality of guest profiles includes but not limited to a guest full legal name, a guest relationship, a guest date of birth, a guest gender identity, and contact information. The guest full legal name and the contact information are compulsory aspect for each of the plurality of guest profiles. The contact information includes a guest email address, a guest phone number, and a guest home address.

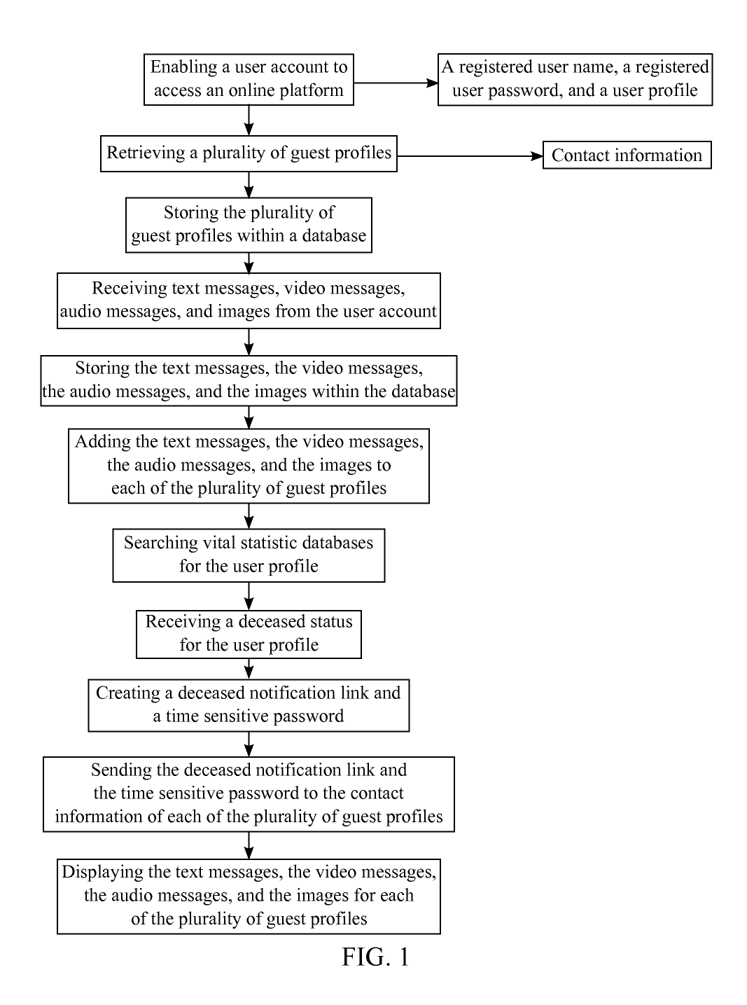

The commemorative messages connect the selected group of individuals with the user only after the user's death. The commemorative messages include but not limited to text messages, video messages, audio messages, images, and any other related form of messages. The commemorative messages are significant for the present invention as the commemorative messages decide the financial aspect of the present invention. In the preferred embodiment, the user can upload the text messages, the video messages, the audio messages, and the images to the online platform through the user account. In reference to FIG. 1, the application software then receives the text messages, the video messages, the audio messages, and the images through the online platform and saves the text messages, the video messages, the audio messages, and the images in the database. The present invention enables the user to individually remove or edit the text messages, the video messages, the images, and the audio messages through the online platform where all of the modified information is saved within the database. The user can organize the audio messages and the video messages in several different ways, including but not limited to chapters, recording length, target audience, and recorded date. The user can selectively assign the text messages, the video messages, the audio messages, and the images each of the plurality of guest profiles upon the user's preference. For example, a first guest profile can be assigned to view the images and the audio messages, but a second guest profile can be assigned to view the text messages and the video messages.

In additional embodiments, different service fees can be assigned to the commemorative messages as the commemorative messages may break down into different services. For example, the commemorative messages can be broken down into three different groups such as a first service, a second service, and a third service where, the first service may include the text messages and the images, and the second service may include the text messages, the images, and the audio messages, and the third service may include the text messages, the images, the audio messages, and the video messages. If the commemorative messages are broken down into different groups, the user has to select a specific service out from the different services during the registration process.

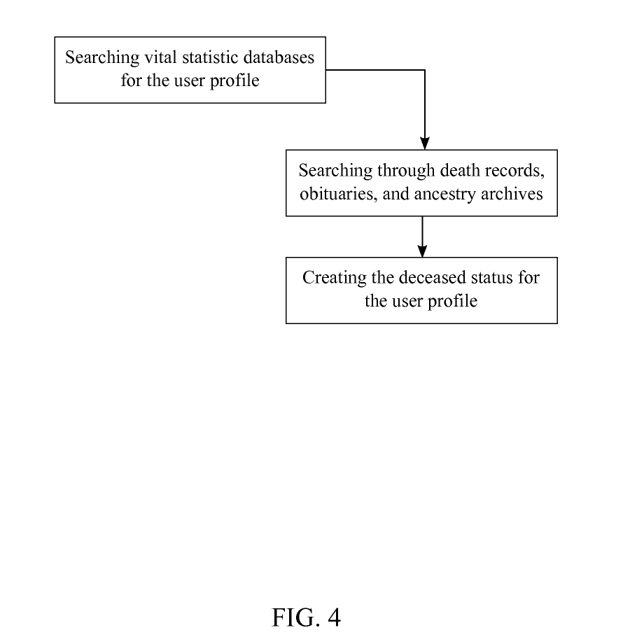

In reference to FIG. 4, the application software continuously searches vital statistic databases for similar information regarding the user profile where the vital statistic databases comprise information about deceased peoples. The vitality database comprises death records, obituaries, ancestry archives, and other related information about deceased people. The application software retrieves a deceased status for the user profile when the uploaded information in the user profile matches with similar information in the vital statistic databases, indicating that the user has died. An automated independent party may confirm the accuracy of the matching information to insure the proper functionality of the present invention. Since the application software conducts all of the functionality aspect of the present invention, the present invention is completely automated and the lag time is kept to a minimum.

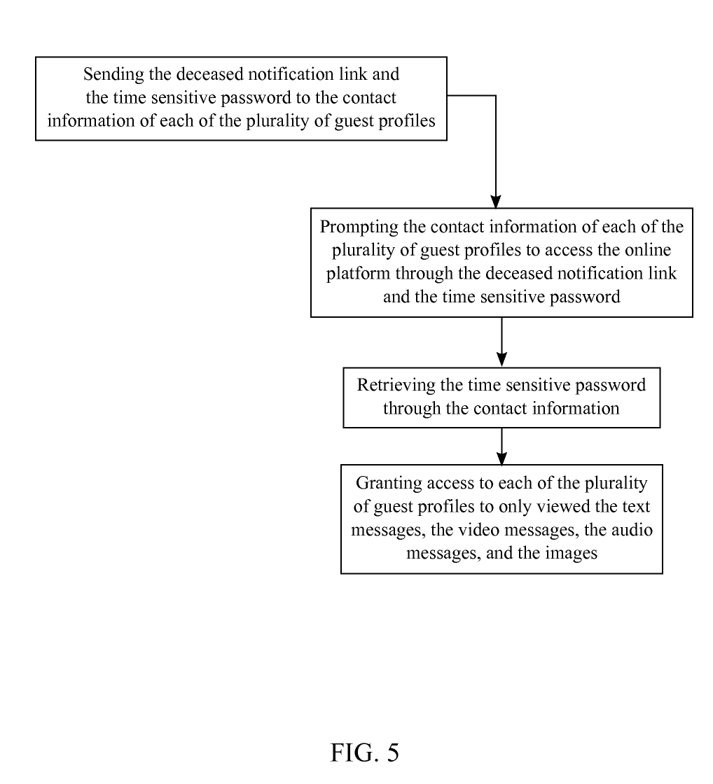

Then the present invention creates a deceased notification link and a time sensitive password, if the deceased status receives from the vital statistic databases. In reference to FIG. 5, the application software then sends the deceased notification link and the time sensitive password to a plurality of guests through the contact information to each of the plurality of guest profiles. All of the information in the user account is kept secured and confidential within the online platform and the database until this point, and the plurality of guests is only contacted after the deceased notification link and the time sensitive password are created by the application software. The present invention identifies each of the plurality of guests with reference to each of the plurality of guest profiles. In the preferred embodiment, the deceased notification link is sent to each of the plurality of guests as an electronic message where the sending of the deceased notification link is strictly decided by the contact information. The deceased notification link and the time sensitive password can also be sent as a physical letter along with the electronic message or without the electronic message. If the present invention unable to sends the deceased notification link as the electronic message, the deceased notification link can send to the plurality of guests as the physical letter. The deceased notification link may also send to a genealogy matrix so that the user's death can be recorded in a public record system.

The deceased notification link prompts each of the plurality of guests to access the online platform with the time sensitive password. Once the application software retrieves the time sensitive password through each of the contact information from each of the plurality of guests, the application software authenticates the time sensitive password with reference to each of the plurality of guest profiles. After completing the authentication of the time sensitive password and each of the plurality of guest profiles, each of the plurality of guests can access the online platform to view the commemorative messages. Since the user selectively assigns each of the plurality of guest profiles with the text messages, the video messages, the audio messages, and the images, each of the plurality of guests is only able to view what is assigned by the user. The commemorative messages can't be altered by the plurality of guests or any other sources. The present invention allows each of the plurality of guests download the text messages, the images, the video messages, and the audio messages into their personal computing devices since the time sensitive password has a predetermined number of reviews. The time sensitive password is programmed with the predetermined number of reviews so that the plurality of commemorative messages can't be regularly activated by the deceased notification link and the time sensitive password.

Although the invention has been explained in relation to its preferred embodiment, it is to be understood that many other possible modifications and variations can be made without departing from the spirit and scope of the invention as hereinafter claimed.

What is claimed is:

1. A method of recording and delivering messages by executing computer-executable instructions stored on a non-transitory computer-readable medium, the method comprises the steps of:
providing a user account, wherein the user account includes a registered user name, a registered user password, and a user profile;
enabling the user account to access an online platform;
retrieving a plurality of guest profiles from the user account through the online platform, wherein each of the plurality of guest profiles includes contact information;
storing the plurality of guest profiles within a database, wherein the database is interconnected with the online platform;
receiving text messages, video messages, audio messages, and images from the user account through the online platform;
storing the text messages, the video messages, the audio messages, and the images within the database;
selectively adding the text messages, the video messages, the audio messages, and the images to each of the plurality of guest profiles;
continuously searching vital statistic databases for the user profile, wherein the vital statistic databases comprises information about deceased people;
receiving a deceased status for the user profile from the vital statistic databases;
creating a deceased notification link and a time sensitive password,
if the deceased status is received from the vitality databases;
sending the deceased notification link and the time sensitive password to the contact information of each of the plurality of guest profiles; and
selectively displaying the text messages, the video messages, the audio messages, and the images for each of the plurality of guest profiles through the online platform,
if the time sensitive password is retrieved from the deceased notification link for each of the plurality of guest profiles.

2. The method of recording and delivering messages by executing computer-executable instructions stored on a non-transitory computer-readable medium, the method as claimed in claim 1 further comprises the steps of:
prompting the user account to complete the user profile by entering a user full legal name, a user email address, a user home address, a user date of birth, and a user gender identity;
prompting the user account to create the registered user name and the registered user password; and
storing the user profile, the registered user name, and the registered user password in the database.

3. The method of recording and delivering messages by executing computer-executable instructions stored on a non-transitory computer-readable medium, the method as claimed in claim 1 further comprises the steps of:
prompting the user account to complete each of the plurality of guest profiles with a guest full legal name, a guest relationship, a guest date of birth, and a guest gender identity; and
prompting the user account to enter a guest email address, a guest home address, and a guest phone number as the contact information of each of the plurality of guest profiles.

4. The method of recording and delivering messages by executing computer-executable instructions stored on a non-transitory computer-readable medium, the method as claimed in claim 1 further comprises the steps of:
wherein the user profile further comprises a genealogy map that includes the user profiles and other related user profiles to create a family tree.

5. The method of recording and delivering messages by executing computer-executable instructions stored on a non-transitory computer-readable medium, the method as claimed in claim 1 further comprises the steps of:
searching through death records, obituaries, and ancestry archives of the vital statistic databases; and
creating the deceased status for the user profile,
if the user profile matches with personal information of deceased individual within the vitality database.

6. The method of recording and delivering messages by executing computer-executable instructions stored on a non-transitory computer-readable medium, the method as claimed in claim 1 further comprises the steps of:
prompting the contact information of each of the plurality of guest profiles to access the online platform through the deceased notification link and the time sensitive password;
retrieving the time sensitive password through the contact information of each of the plurality of guest profiles, wherein the time sensitive password has a predetermined number of reviews; and
granting access to each of the plurality of guest profiles to only viewed the text messages, the video messages, the audio messages, and the images.
